(19) United States
(12) Patent Application Publication
(10) Pub. No.: US 2022/0312677 A1
(43) Pub. Date: Oct. 6, 2022

(54) GRASS BAG AND TRANSPORTATION STRUCTURE THEREOF

(71) Applicant: Honda Motor Co., Ltd., Tokyo (JP)

(72) Inventors: Ante KROLO, Offenbach/Main (DE); Ronny BORSDORF, Offenbach/Main (DE); Eric WRASE, Offenbach/Main (DE)

(73) Assignee: Honda Motor Co., Ltd., Tokyo (JP)

(21) Appl. No.: 17/218,139

(22) Filed: Mar. 30, 2021

(51) Int. Cl. A01D 43/063

(52) U.S. Cl. CPC A01D 43/0636; A01D 43/0635; A01D 2101/00

(57) ABSTRACT

A grass bag structure is provided. The grass bag structure includes a bag frame, a handle and a plurality of wheels. The handle is disposed on the grass bag and adapted for transporting the grass bag.

### BACKGROUND

### Technical Field

The disclosure relates to a grass bag of a lawn mower, and specifically relates to a structure adapted for transporting the grass bag.

### Description of Related Art

Conventionally, when the grass bag of a lawn mower becomes full, the grass bag is carried on the hands of a user to dump out the grass that is inside the grass bag. However, carrying the heavy grass bag to a dumping area on hands may cause back pain or discomfort to the user.

Therefore, a solution is needed to transport the grass bag in an easier and more comfortable way by carrying the grass bag on wheels.

### SUMMARY

According to an embodiment of the disclosure, a grass bag structure is provided. The grass bag structure includes a bag frame, a handle and a plurality of wheels. The handle is disposed on the grass bag and adapted for transporting the grass bag.

According to an embodiment of the disclosure, the handle includes a rotating part having a pivot point, adapted to fold the handle when the handle is not in use.

According to an embodiment of the disclosure, the bag frame includes a base frame, a second rod and a third rod. The second rod and the third rod extend from the base frame. The grass bag structure includes a second shaft connected with a third shaft forming a front shaft, a fourth shaft connected with a fifth shaft forming a rear shaft, wherein the front shaft is coupled to the second rod and the third rod, and the rear shaft is coupled to the second rod and the third rod, and the rotating part of the handle is disposed on the front shaft.

According to an embodiment of the disclosure, the plurality of wheels are disposed on the rear shaft.

According to an embodiment of the disclosure, an end of the handle away from the rotating part is fixed to the rear shaft.

According to an embodiment of the disclosure, the end of the handle away from the rotating part includes a half cylinder shape having a substantially same shape as a shape of the rear shaft.

According to an embodiment of the disclosure, the grass bag structure further includes a first shaft connecting the front shaft and the rear shaft.

According to an embodiment of the disclosure, the handle includes a first handle shaft and a second handle shaft connecting the handle with the pivot point respectively, and the first handle shaft and the second handle shaft are separated by a space, the space is greater than a width of the first shaft.

According to an embodiment of the disclosure, the grass bag structure further includes a stand pipe extending from the rear shaft in a direction of the base frame.

According to an embodiment of the disclosure, the handle further includes a telescopic rod configured to fold the handle when the handle is not in use.

According to an embodiment of the disclosure, the grass bag structure further includes a cover configured to cover an opening of the grass bag, and the handle of the grass bag is provided with a latching part configured to latch onto the cover.

According to an embodiment of the disclosure, the latching part comprises a magnet.

According to an embodiment of the disclosure, the plurality of wheels are disposed on a base frame side of the grass bag structure, and each of the plurality of wheels include a wheel pivot point located away from a rotation axis of the wheel respectively.

According to an embodiment of the disclosure, a lawn mower is provided. The lawn mower includes the grass bag structure according to an embodiment of the disclosure, a housing, a driving part including an engine, a working part including a cutter blade disposed rotatably inside the housing, wherein the grass bag is mounted to the housing, and the handle of the grass bag is disposed on a side of the grass bag away from the working part.

According to an embodiment of the disclosure, a lawn mower is provided. The lawn mower includes the grass bag structure according to an embodiment of the disclosure, a housing, a driving part including an engine, a working part including a cutter blade disposed rotatably inside the housing, wherein the grass bag is mounted to the housing, and the plurality of wheels are disposed on a side of the grass bag away from the engine.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures.

FIG. 1 is a schematic diagram illustrating a perspective view of a grass bag structure according to an embodiment of the disclosure.

FIG. 2 is a schematic diagram illustrating a perspective view of a grass bag structure in which a handle is in the storage state according to an embodiment of the disclosure.

FIG. 3 is a schematic diagram illustrating a latching part of a grass bag according to an embodiment of the disclosure.

FIG. 4 is a schematic diagram illustrating a side view of a grass bag structure in which the handle is in the extended state according to an embodiment of the disclosure.

FIG. 5 is a schematic diagram illustrating a grass bag structure mounted to a housing of a lawn mower according to an embodiment of the disclosure.

FIG. 6 is a schematic diagram illustrating a mounting structure of a grass bag configured for mounting to a housing of a lawn mower according to an embodiment of the disclosure.

FIG. 7 is a schematic diagram illustrating a mounting structure of a housing of a lawn mower configured for mounting by a grass bag according to an embodiment of the disclosure.

FIG. 8 is a schematic diagram illustrating a configuration of a wheel and a handle of the grass bag with respect to the housing of the lawn mower according to an embodiment of the disclosure.

FIG. 9 is a schematic diagram illustrating a configuration of a wheel and a handle of the grass bag with respect to the housing of the lawn mower according to an embodiment of the disclosure.

FIG. 10 is a schematic diagram illustrating a configuration of a wheel and a handle of the grass bag with respect to the housing of the lawn mower according to an embodiment of the disclosure.

FIG. 11A is a schematic diagram illustrating a configuration of a wheel of a grass bag according to an embodiment of the disclosure.

FIG. 11B is a schematic diagram illustrating a configuration of a wheel of a grass bag according to an embodiment of the disclosure.

FIG. 12 is a schematic diagram illustrating a concept of carrying a grass bag to a dumping area and dumping out the grass according to an embodiment of the disclosure.

FIG. 13 is a schematic diagram illustrating a top view of an extendable and retractable trolly unit according to an embodiment of the disclosure.

FIG. 14 is a schematic diagram illustrating a top view of an extendable and retractable trolly unit according to an embodiment of the disclosure.

### DESCRIPTION OF THE EMBODIMENTS

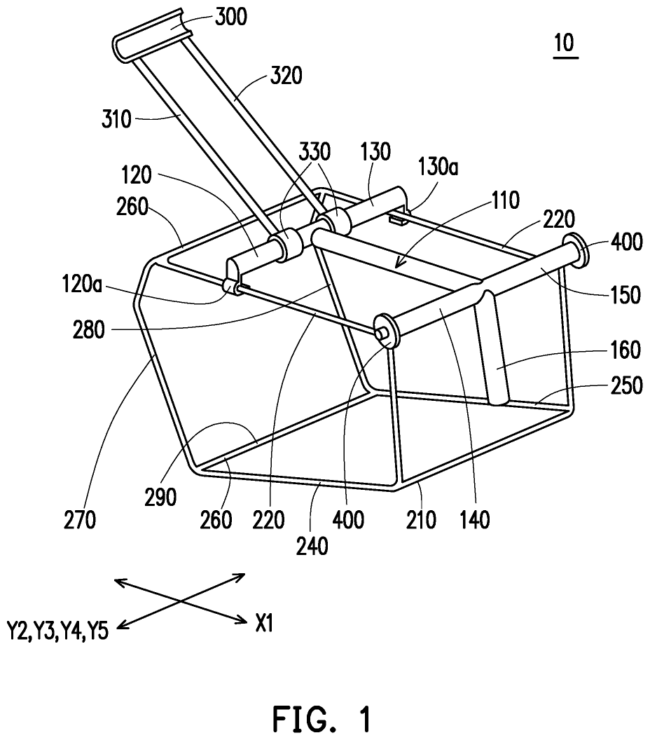

According to an exemplary embodiment of the disclosure, a bag structure adapted for a lawn mower is provided. FIG. 1 is a schematic diagram illustrating a perspective view of a grass bag structure according to an embodiment of the disclosure. Referring to FIG. 1, a grass bag structure 10 is provided. The grass bag structure 10 is an example of a bag structure of the disclosure. The grass bag structure 10 includes a trolly unit 100 and a bag frame 200.

The trolly unit 100 includes a first shaft 110, a second shaft 120, a third shaft 130, a fourth shaft 140, a fifth shaft 150, and a stand pipe 160. The first shaft 110 extends in a first direction X1, and has a first end, a second end and a middle portion connecting the first end and the second end of the first shaft. The second shaft 120 extends in a second direction Y2, and has a first end, a second end and a middle portion connecting the first end and the second end of the second shaft 120. The first end of the second shaft 120 is coupled to the first end of the first shaft 110. The third shaft 130 extends in a third direction Y3, and has a first end, a second end and a middle portion connecting the first end and the second end of the third shaft 130. The first end of the third shaft 130 is coupled to the first end of the first shaft 110. In the present embodiment, the first end of the second shaft 120 and the first end of the third shaft 130 are both coupled to the first end of the first shaft 110. However, the disclosure is not limited thereto. In another embodiment of the disclosure, the first end of the second shaft 120 may be coupled to the first end of the third shaft 130 to form a front shaft. In other words, the second shaft 120 is connected with the third shaft 130 to form the front shaft. The first end of the first shaft 110 may then be coupled with the front shaft formed by the second shaft 120 and the third shaft 130. However, in another embodiment of the disclosure, the first shaft 110 may be omitted as well.

The fourth shaft 140 extends in a fourth direction Y4, and has a first end, a second end and a middle portion connecting the first end and the second end of the fourth shaft 140. The first end of the fourth shaft 140 is coupled to the second end of the first shaft 110. The fifth shaft 150 extends in a fifth direction Y5, and has a first end, a second end and a middle portion connecting the first end and the second end of the fifth shaft 150. The first end of the fifth shaft 150 is coupled to the second end of the first shaft 110. In the present embodiment, the first end of the fourth shaft 140 and the first end of the fifth shaft 150 are both coupled to the second end of the first shaft 110. However, the disclosure is not limited thereto. In another embodiment of the disclosure, the first end of the fourth shaft 140 may be coupled to the first end of the fifth shaft 130 to form a rear shaft. In other words, the fourth shaft 140 is connected with the fifth shaft 150 to form the rear shaft. The second end of the first shaft 110 may then be coupled with the rear shaft formed by the fourth shaft 140 and the fifth shaft 150. That is to say, the first shaft connects the front shaft and the rear shaft. By connecting the front shaft and the rear shaft with the first shaft 110, the front shaft and the rear shaft may be integrated into a single structure, and a strength of the grass bag structure 10 may be increased. In addition, the first shaft 110 may be gripped by the user during transport of the grass bag structure 10. However, in another embodiment of the disclosure, the first shaft 110 may be omitted all together. In other words, an embodiment of the disclosure may have no first shaft 110 that connects the front shaft with the rear shaft.

The stand pipe 160 has a first end, second end and a middle portion connecting the first end and the second end of the stand pipe 160. The second end of the stand pipe 160 is coupled to the second end of the first shaft 110. In this way, the grass bag structure 10 may be stood up in an upright position.

The second direction Y2, the third direction Y3, the fourth direction Y4 and the fifth direction Y5 are directions crossing the first direction X1. In other words, the second direction Y2, the third direction Y3, the fourth direction Y4 and the fifth direction Y5 are not parallel to the first direction X1.

In the embodiment shown in FIG. 1, the second direction Y2 is parallel to the third direction Y3. More specifically, the second shaft 120 and the third shaft 130 extend along a same axis. In addition, the fourth direction Y4 is parallel to the fifth direction Y5. That is to say, the fourth shaft 140 and the fifth shaft 150 extend along a same axis.

The bag frame 200 includes a base frame 210, a second rod 220, a third rod 230, a fourth rod 240 and a fifth rod 250. The base frame 210 is disposed on the stand pipe 160 of the trolly unit 100. One end of the second rod 220, one end of the third rod 230, one end of the fourth rod 240 and one end of the fifth rod 250 are connected to the base frame 210, respectively. In other words, the second rod 220, the third rod 230, the fourth rod 240 and the fifth rod 250 extend from the base frame 20, respectively. In addition, the stand pipe 160 extends from the rear shaft (fourth shaft 140 and fifth shaft 150), or from the second end of the first shaft 110 in a direction of the base frame 210. A first opening rod 260 connects the other end of the second rod 220 with the other end of the third rod 230. A second opening rod 270 connects the other end of the second rod 220 with the other end of the fourth rod 240. A third opening rod 280 connects the other end of the third rod 230 with the other end of the fifth rod 250. A fourth opening rod 290 connects the other end of the fourth rod 240 with the other end of the fifth rod 250. In this way, an opening O is formed in the bag frame 200 by the first opening rod 260, the second opening rod 270, the third opening rod 280 and the fourth opening rod 290. The first opening rod 260, the second opening rod 270, the third opening rod 280 and the fourth opening rod 290 which form the opening O is an example of an inlet frame of the grass bag structure 10. The opening O is adapted for the cut grass to enter the grass bag structure 10 during mowing of the lawn by the lawn mower 10. In addition, the opening O is adapted for dumping out the grass that is inside the grass bag.

The second shaft 120 is coupled to the second rod 220. In more detail, the second shaft 120 includes a fixing part 120a disposed at the second end of the second shaft 120. The fixing part 120a of the second shaft 120 is fixed to the second rod 220. More specifically, the fixing part 120a includes a curved surface which contacts a surface of the second rod 220. The curved surface of the fixing part 120a is configured to latch onto a curved surface of the second rod 220 such that the fixing part 120a may be fixed to the second rod 220. In other words, the curved surface of the fixing part 120a clamps onto the curved surface of the second rod 220. In the present embodiment, the fixing part 120a of the second shaft 120 is detachably fixed to the second rod 220 by clamping. That is to say, in the present embodiment, the fixing part 120a may be detached from the second rod 220. However, in other embodiments the second shaft 120 may be fixed to the second rod 220 by an adhesive, welding, sonic welding or the like. In other words, the fixing part 120a of the second shaft 120 is not required to be detachable from the second rod 220.

Similarly, the second end of the third shaft 130 is coupled to the third rod 230. In more detail, the third shaft 130 includes a fixing part 130a disposed at the second end of the third shaft 130. The fixing part 130a of the third shaft 130 is fixed to the third rod 230. More specifically, the fixing part 130a includes a curved surface which contacts a surface of the third rod 230. The curved surface of the fixing part 130a is configured to latch onto a curved surface of the third rod 230 such that the fixing part 130a may be fixed to the third rod 230. In other words, the curved surface of the fixing part 130a clamps onto the curved surface of the third rod 230. In the present embodiment, the fixing part 130a of the third shaft 130 is detachably fixed to the third rod 230 by clamping. That is to say, in the present embodiment, the fixing part 130a may be detached from the third rod 230. However, in other embodiments the third shaft 130 may be fixed to the third rod 230 by an adhesive, welding, sonic welding or the like. In other words, the fixing part 130a of the third shaft 130 is not required to be detachable from the third rod 230.

The fourth shaft 140 is coupled to the second rod 220. In more detail, the fourth shaft 140 includes a fixing part 140a disposed at the second end of the fourth shaft 140. The fixing part 140a of the fourth shaft 120 is fixed to the second rod 220. More specifically, the fixing part 140a includes a curved surface which contacts a surface of the second rod 220. The curved surface of the fixing part 140a is configured to latch onto a curved surface of the second rod 220 such that the fixing part 140a may be fixed to the second rod 220. In other words, the curved surface of the fixing part 140a clamps onto the curved surface of the second rod 220. In the present embodiment, the fixing part 140a of the fourth shaft 120 is detachably fixed to the second rod 220 by clamping. That is to say, in the present embodiment, the fixing part 140a may be detached from the second rod 220. However, in other embodiments the fourth shaft 140 may be fixed to the second rod 220 by an adhesive, welding, sonic welding or the like. In other words, the fixing part 140a of the fourth shaft 140 is not required to be detachable from the second rod 220.

Similarly, the second end of the fifth shaft 150 is coupled to the third rod 230. In more detail, the fifth shaft 150 includes a fixing part 150a disposed at the second end of the fifth shaft 150. The fixing part 150a of the fifth shaft 150 is fixed to the third rod 230. More specifically, the fixing part 150a includes a curved surface which contacts a surface of the third rod 230. The curved surface of the fixing part 150a is configured to latch onto a curved surface of the third rod 230 such that the fixing part 150a may be fixed to the third rod 230. In other words, the curved surface of the fixing part 150a clamps onto the curved surface of the third rod 230. In the present embodiment, the fixing part 150a of the fifth shaft 150 is detachably fixed to the third rod 230 by clamping. That is to say, in the present embodiment, the fixing part 150a may be detached from the third rod 230. However, in other embodiments the fifth shaft 150 may be fixed to the third rod 230 by an adhesive, welding, sonic welding or the like. In other words, the fixing part 150a of the fifth shaft 150 is not required to be detachable from the third rod 230.

As described above, the front shaft (the second shaft 120 and the third shaft 130) and the rear shaft (the fourth shaft 140 and the fifth shaft 150) are coupled to the second rod 220 and the third rod 230. In addition, the fourth shaft 140 and the fifth shaft 150 may be coupled to the base frame 210 in a similar manner as described above. That is to say, the fourth shaft 140 and the fifth shaft 150 may include a fixing part (not shown) disposed on the fourth shaft 140 and the fifth shaft, respectively. The fixing parts of the fourth shaft 140 and the fifth shaft 150 may be detachably fixed to the base frame 210 by clamping. That is to say, in the present embodiment, the fixing parts of the fourth shaft 140 and the fifth shaft 150 may be detached from the base frame 210. However, in other embodiments, the fourth shaft 140 and the fifth shaft may be fixed to the base frame 210 by an adhesive, welding, sonic welding or the like. In other words, the fixing parts of the fourth shaft 140 and the fifth shaft 150 are not required to be detachable from the base frame 210.

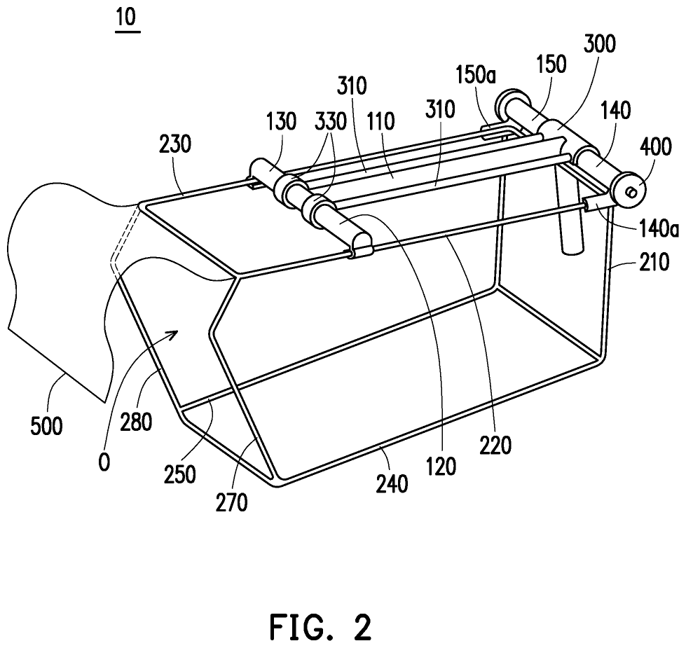

As described above, the front shaft (the second shaft 120 and the third shaft 130) and the rear shaft (the fourth shaft 140 and the fifth shaft 150) are coupled to the second rod 220 and the third rod 230, and the rear shaft is coupled to the base frame 210. In the embodiments where the trolly unit 100 (including the second shaft 120, the third shaft 130, the fourth shaft 140, the fifth shaft 150) is detachably fixed to the bag frame 200 (including the base frame 210, second rod 220, and the third rod 230), then the trolly unit 100 may be configured as a separate unit that may be detachably attached to already existing grass bags. The detachable fixing parts 120a, 130a, 140a, 150a may be a clamp in which the surface of the clamp may clamp onto the base frame 210, the second rod 220 and the third rod 230 respectively. In this way, the trolly unit 100 may be easily attached and detached from the bag frame 200 using the clamp. It should be noted, although a direction of clamping shown in FIG. 1 and FIG. 2 shows the fixing part 120a, 130a, 140a, 150a clamping the bag frame 200 from a peripheral direction of the grass bag 200 inward, however the disclosure is not limited thereto. In other words, the fixing parts 120a, 130a, 140a, 150a may clamp the base frame 210, the second rod 220 and the third rod 230 from any direction respectively (such as from the inside of the bag frame 200 towards the outside periphery of the bag frame 200 and the like).

The grass bag structure 10 includes a handle 300 and a plurality of wheels 400 adapted for transporting the grass bag structure 10. In this way, the user may transport the grass bag structure with ease. The wheels 400 may be detachably attached to the grass bag structure 10. The handle 300 is disposed on the grass bag structure 10. In the embodiment of FIG. 1, the handle 400 and the plurality of wheels 400 are disposed on a same side of the grass bag structure 10. However, the disclosure is not limited thereto. In another embodiment of the disclosure, the handle 400 and the plurality of wheels 400 may be disposed on different sides of the grass bag structure 10. More specifically, the plurality of wheels 400 may be disposed on the rear shaft. That is to say, a wheel 400 may be disposed on the fourth shaft 140, and a wheel 400 may be disposed on the fifth shaft 150.

In more detail, the handle 300 includes a pivot point 330 such that the handle 300 may be rotated about the pivot point 300. The pivot point 330 is an example of a rotating part of the handle 300. The rotating part (pivot point 330) of the handle 300 is disposed on the front shaft (the second shaft 120 and the third shaft 130). The handle 300 includes a first handle shaft 310 and a second handle shaft 320 connecting the handle 300 with the pivot point 330 respectively, and the first handle shaft 310 and the second handle shaft 320 are separated by a space. In more detail, the handle 300 includes the first handle shaft 310 and the second handle shaft 320 extending from the handle 300 towards the pivot point 330. The first handle shaft 310 and the second handle shaft 320 each connect with the pivot point 330. In the present embodiment, the pivot point 330 of the handle 300 is rotatably coupled to the second shaft 120 and the third shaft 130. The end of the handle 300 away from the rotating part 330 includes a half cylinder shape having a substantially same shape as a shape of the rear shaft (fourth shaft 140 and fifth shaft 150). In this way, the handle 300 may be fixed to the rear shaft by abutting the handle 300 to the rear shaft. In this way, the handle 300 does not get in the way when not transporting the grass bag structure 10. In more detail, the pivot point 330 of the handle 300 includes a ring structure wherein the second shaft 120 and the third shaft 130 passes through the ring of the ring structure of pivot point 330. In other words, in the present embodiment, the pivot point 300 includes a hollow cylinder, wherein the second shaft 120 and the third shaft 130 passes through the hollow portion of the hollow cylinder. In this way, the handle 300, the first handle shaft 310 and the second handle shaft 320 may rotate about the second shaft 120 and the third shaft 130 through the pivot point 300. A position of the hollow cylinder may be fixed in the axial direction of the second shaft 120 and the axial direction of the third shaft 130 by, for example, a locking ring. However, the disclosure is not limited thereto.

In another embodiment of the disclosure, the pivot point 300 of the handle 300 may be rotatably coupled to other portions of the grass bag structure 10, instead of being coupled to the second shaft 120 and the third shaft 130. For example, in another embodiment of the disclosure, the pivot point 300 of the handle may be rotatably coupled to the first shaft 110 of the trolly unit 100. In another embodiment of the disclosure, the handle 300 may be rotatably coupled to a fabric disposed on the bag frame 200.

FIG. 2 is a schematic diagram illustrating a perspective view of a grass bag structure in which a handle is in the storage state according to an embodiment of the disclosure. Referring to FIG. 2, the pivot point 330 is adapted to fold the handle when the handle is not in use. In this way, the handle 300 does not protrude from the grass bag structure 10 except during transportation and the handle 300 does not get in the way of user when mowing the lawn. In the storage stage of the grass bag structure 10, the handle 300 is coupled to the fourth shaft 140 and the fifth shaft 150. In more detail, the handle 300 is fixed to the fourth shaft 140 and the fifth shaft 150. That is to say, an end of the handle 300 away from the rotating part 330 is fixed to the rear shaft (the fourth shaft 140 and fifth shaft 150). More specifically, the handle 300 includes a curved surface which contacts a surface of the fourth shaft 140 and a surface of the fifth shaft 150. The curved surface of the handle 300 is configured to latch onto a curved surface of the fourth shaft 140 and the fifth shaft 150 such that the handle 300 may be fixed to the fourth shaft 140 and the fifth shaft 150. In other words, the curved surface of the handle 300 clamps onto the curved surfaces of the fourth shaft 140 and the fifth shaft 150. The handle 300 is detachably fixed to the fourth shaft 140 and the fifth shaft 150, such that the handle 300 may be detached from the fourth shaft 140 and the fifth shaft 150 to pull the grass bag structure 10 when the grass bag structure 10 needs to be transported. In an embodiment of the disclosure, the space disposed between the first handle shaft 310 and the second handle shaft 320 may be greater than a width of the first shaft 110. By including a space between the first handle shaft 310 and the second handle shaft 320 that is greater than the width of the first shaft 110, the user may still grip the first shaft 110 even in the storage state of the handle 300. That is, there is enough space for the user to grip the first shaft 110 even when the handle 300 is fixed to the fourth shaft 140 and the fifth shaft 150.

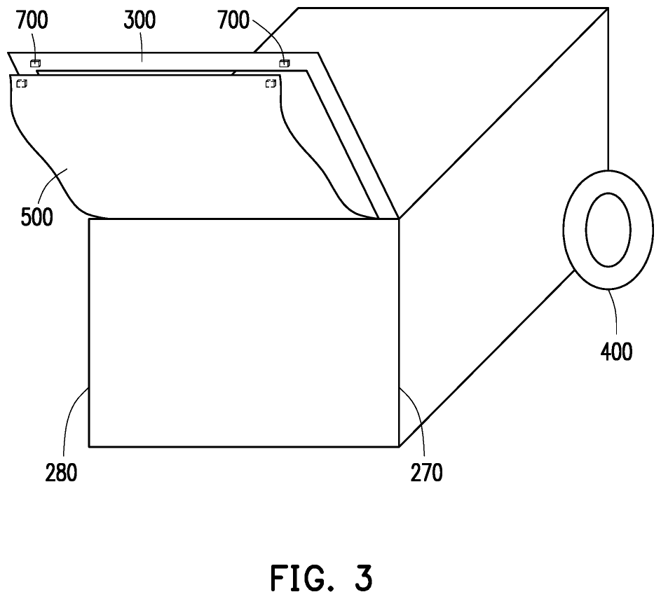

FIG. 3 is a schematic diagram illustrating a latching part of a grass bag according to an embodiment of the disclosure. FIG. 3 is a simplified drawing for illustrating the latching part only, and the specific components of the grass bag structure 10 such as the first shaft 110, the second shaft 120, the third shaft 130, the fourth shaft 140, the first shaft 150 and the like are omitted. Referring to FIG. 3, the grass bag structure 10 further includes a cover 500 configured to cover the opening O of the grass bag structure 10. A material of the cover 500 may be a fabric, plastic, metal and the like. A material of the cover 500 is not intended to limit the disclosure. When transporting the grass bag structure 10, the cover 500 may prevent the grass inside the grass bag structure 10 from spilling out. In addition, a latching part 700 may be provided on any portion of the handle such as the handle 300, the first handle shaft 310, the second handle shaft 320 and the like. The latching part 700 is configured to latch onto the cover 500 to prevent the cover 500 from covering the opening O. In this way, when the cut grass in the grass bag structure 10 is being dumped out of the grass bag structure 10, the cover 500 will not get in the way of the grass being dumped. The latching part 700 may be, for example, a magnet, a hook and the like. When the latching part 700 provided, for example, on the handle 300 is a magnet, then a magnet may be disposed on the cover 500 correspondingly. In the present embodiment of the disclosure, the latching part 700 is disposed on the handle 300, however the disclosure is not limited thereto. In another embodiment, the latching part 700 may be disposed on other parts of the grass bag structure 10. In this way, the cover 500 may be easily latched to the grass bag structure 10.

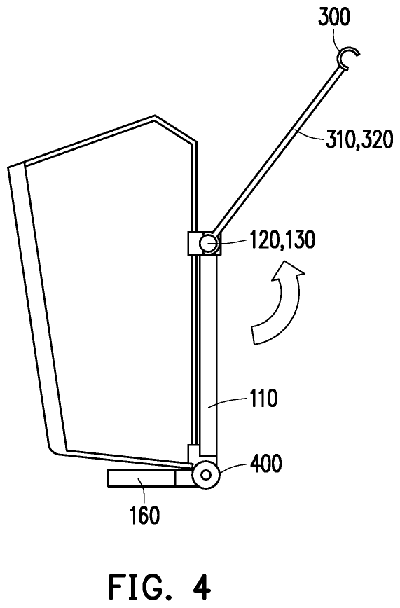

FIG. 4 is a schematic diagram illustrating a side view of a grass bag structure in which the handle is in the extended state according to an embodiment of the disclosure. The “handle is in the extended state” refers to a state of the handle 300 when the grass bag structure 10 is to be transported. The handle 300 may be gripped by the user for easy transport.

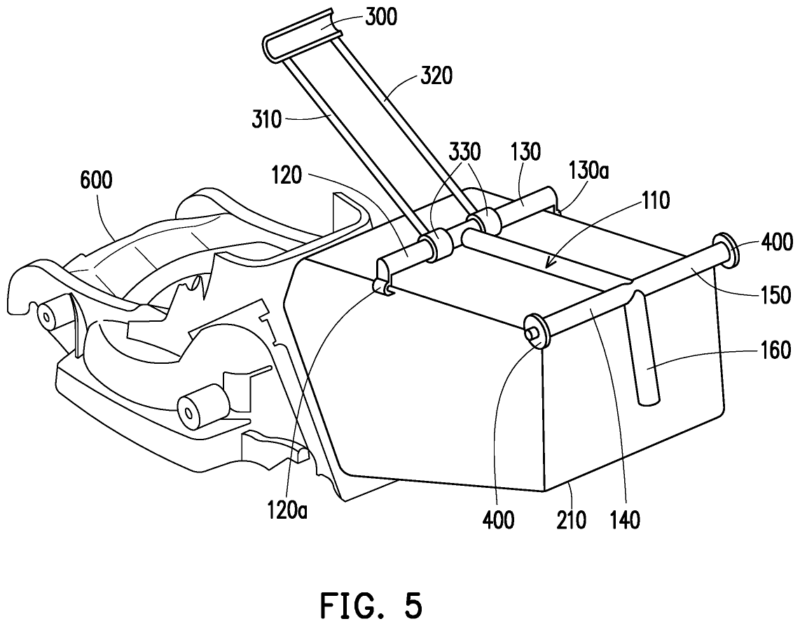

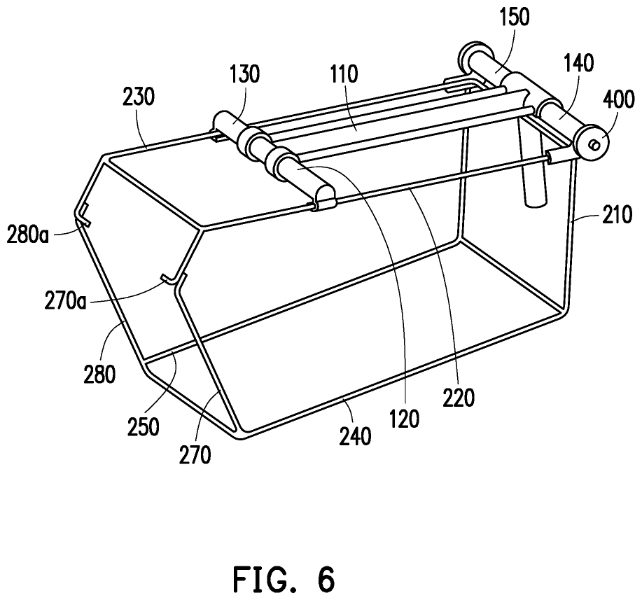

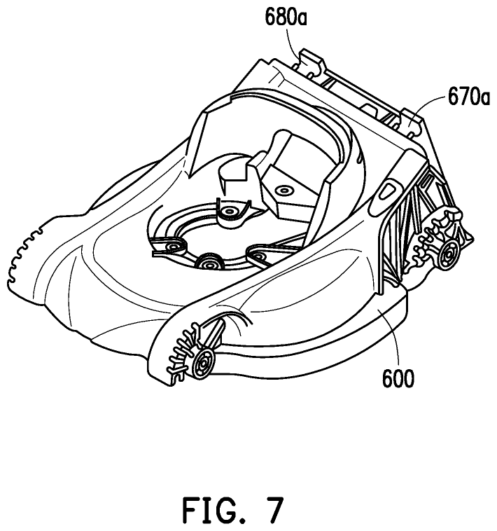

FIG. 5 is a schematic diagram illustrating a grass bag structure mounted to a housing of a lawn mower according to an embodiment of the disclosure. FIG. 6 is a schematic diagram illustrating a mounting structure of a grass bag configured for mounting to a housing of a lawn mower according to an embodiment of the disclosure. FIG. 7 is a schematic diagram illustrating a mounting structure of a housing of a lawn mower configured for mounting by a grass bag according to an embodiment of the disclosure.

Referring to FIG. 5, the grass bag structure 10 is mounted to a housing 600 of a lawn mower. FIG. 5 is a simplified drawing only, and the handle of the lawn mower, the wheels of the lawn mower and the like are omitted. Referring to FIG. 5, the bag frame 200 of FIG. 5 is covered with a fabric or substrate adapted to act as a bag of the grass bag structure 10. In an embodiment of the disclosure, the fabric may be a plurality of pieces of fabric covering the side of the grass bag structure 10 (The opening O may be covered by the cover 500). Similarly, the substrate may be a plurality of pieces of substrates. An opening of the base frame 210 may also be covered using a fabric or a substrate or the like. The fabric/substrate may be attached to the grass bag structure 10 (the trolly unit 100 and/or the bag frame 200 or the like) by any fastening means such as adhesive, tape and/or the like. The specific fastening means is not intended to limit the disclosure. In an embodiment of the disclosure, the fabric or substrate may be disposed between the trolly unit 100 and the bag frame 200. However, the disclosure is not limited thereto. In another embodiment of the disclosure, the fabric or substrate may be disposed on top of the trolly unit 100 and the bag frame 200. In another embodiment of the disclosure, the fabric or substrate may be disposed under the trolly unit 100 and the bag frame 200.

Referring to FIG. 6, a mounting structure 270a and a mounting structure 280a are disposed on the inlet frame of the grass bag structure 10. In more detail, the mounting structure 270a is disposed on the second opening rod 270, and the mounting structure 280a is disposed on the third opening rod 280. The mounting structure 270a and the mounting structure 280a of the grass bag structure 10 are, for example, a protrusion that protrudes from the second opening rod 270 and the third opening rod 280 respectively. More specifically, the mounting structure 270a is disposed away from the ends of the second opening rod 270. Similarly, the mounting structure 280a is disposed away from the ends of the third opening rod 270. The mounting structure 270a and the mounting structure 280a are configured to be mounted to a mounting structure of the housing 600. In the embodiment of FIG. 6, the mounting structure 270a and the mounting structure 280a are shown to protrude inward of the inlet frame. That is, the mounting structures 270a, 280a protrude towards the opening O. However, the disclosure is not limited thereto, and the mounting structures 270a, 280a may protrude in another direction, for example, radial to the opening O.

Referring to FIG. 7, a mounting structure 670a and a mounting structure 680a are disposed on the housing 600 of the lawn mower. The mounting structure 270a and the mounting structure 280a of the grass bag structure 10 are configured to be mounted to the mounting structure 670a and the mounting structure 680a of the housing 600. The mounting structure 670a and the mounting structure 680a of the housing 600 are, for example, a recess formed in the housing 600 respectively. The protrusions included in the mounting structure 270a, 280a may be fitted to the recesses included in the mounting structure 670a, 680a respectively. In this way, the grass bag structure 10 may be mounted to the housing 600 of the lawn mower.

The mounting structure 270a, 280a, 670a, 680a are described above as an example, and the mounting structures of the disclosure is not limited thereto.

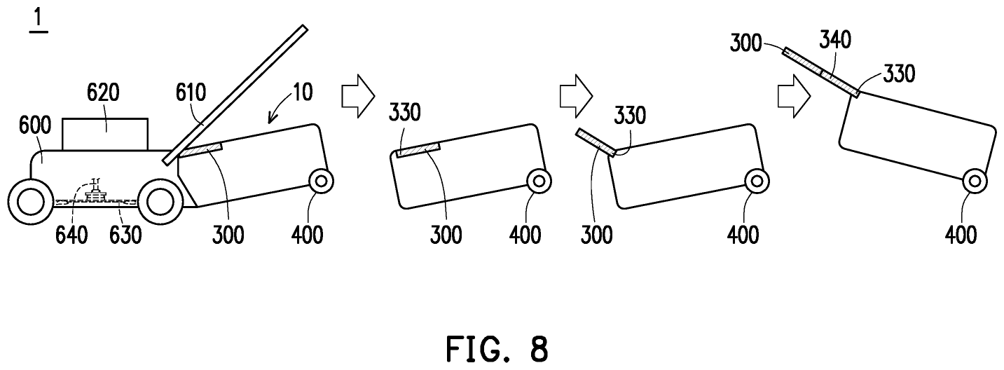

FIG. 8 is a schematic diagram illustrating a configuration of a wheel and a handle of the grass bag with respect to the housing of the lawn mower according to an embodiment of the disclosure. Referring to FIG. 8, the grass bag structure 10 is mounted to the housing 600 of the lawn mower. The lawn mower 1 includes the housing 600, handle 610, an engine 620 and a cutter blade 630. The engine 620 is an example of a driving part. The engine 620 may be a gas engine or an electric motor, and the type of engine or motor is not intended to limit the disclosure. The engine 620 is disposed on one side of the housing 600. In the present embodiment, the one side is an upper side of the housing 600. The cutter blade 630 is disposed on another side of the housing 600. In the present embodiment, the another side is a lower side of the housing 600. Furthermore, the another side of the housing 600 is a side opposite to the one side of the housing 600.

The cutter blade 630 is an example of a working part. The cutter blade 630 is disposed rotatably inside the housing 600, and is coupled to an output shaft 640 of the engine 620. The cutter blade 630 is adapted to cut grass.

In the embodiment of the disclosure shown in FIG. 8, the handle 300 of the grass bag structure 10 is disposed on a side of the grass bag structure 10 away from the working part of the lawn mower 1. In other words, the handle 300 of the grass bag structure 10 is disposed on a side of the housing 600 away from the cutter blade 630. That is to say the handle 300 is positioned on the upper side of the housing 600 such that the handle 300 is positioned closer to the user. In this way, the grass bag structure 10 may be detached from the housing 600 easily since the user may grip the handle 300 when detaching the grass bag structure 10. In addition, in the embodiment of the disclosure of FIG. 8, the handle 300 and the plurality of wheels 400 are disposed on different sides of the grass bag structure 10. That is to say, the plurality of wheels 400 are disposed on a side of the grass bag away from the engine. In other words, the wheels 400 are positioned on the lower side of the housing 600 such that the wheels 400 are positioned away from the user. In this way, it becomes relatively difficult for the wheels 400 to contact the user, such that the clothes of the user getting dirty may be prevented.

Furthermore, in the embodiment of the disclosure of FIG. 8, the handle 300 further includes a telescopic rod 340. The telescopic rod 340 is an example of an extension part. That is to say, the first handle shaft 310 and the second handle shaft 320 may each include a telescopic rod 340, respectively. After the handle 300 is rotated about the pivot point 330 and into the transport state, the telescopic rod 340 of the first handle shaft 310, and the telescopic rod 340 of the second handle shaft 320 may be extended in order to extend a length of the handle 300. The telescopic rod 340 is adapted to fold the handle when the handle is not in use. In this way, the handle 300 does not protrude from the grass bag structure 10 except during transportation and the handle 300 does not get in the way of user when mowing the lawn.

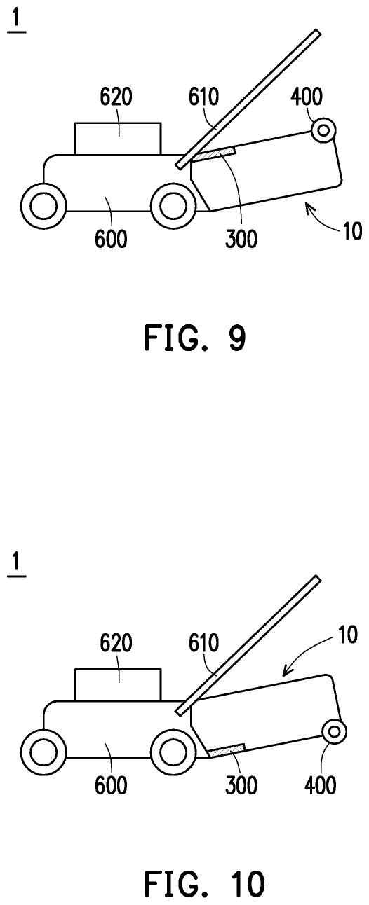

Although, a configuration of the handle 300 and the wheels 400 in FIG. 8 have been described, a configuration of the handle 300 and the wheels 400 is not limited thereto. FIG. 9 is a schematic diagram illustrating a configuration of a wheel and a handle of the grass bag with respect to the housing of the lawn mower according to an embodiment of the disclosure. Referring to FIG. 9, the handle 400 and the plurality of wheels 400 are disposed on a same side of the grass bag structure 10. In the present embodiment, the handle 300 and the wheels 400 of the grass bag structure 10 are disposed on a side of the grass bag structure 10 away from the working part of the lawn mower 1. In other words, the handle 300 and the wheels 400 of the grass bag structure 10 are disposed on a side of the housing 600 away from the cutter blade 630. That is to say the handle 300 and the wheels 400 are positioned on the upper side of the housing 600 such that the handle 300 and the wheels 400 are positioned closer to the user.

FIG. 10 is a schematic diagram illustrating a configuration of a wheel and a handle of the grass bag with respect to the housing of the lawn mower according to an embodiment of the disclosure. Referring to FIG. 10, the handle 400 and the plurality of wheels 400 are disposed on a same side of the grass bag structure 10. In the present embodiment, the handle 300 and the wheels 400 of the grass bag structure 10 are disposed on a side of the grass bag structure 10 away from the engine 620 of the lawn mower 1. In other words, the handle 300 and the wheels 400 of the grass bag structure 10 are disposed on a side of the housing 600 away from the engine 620. That is to say the handle 300 and the wheels 400 are positioned on the lower side of the housing 600 such that the handle 300 and the wheels 400 are positioned away from the user. In this way, it becomes relatively difficult for the wheels 400 to contact the user, such that the clothes of the user getting dirty may be prevented.

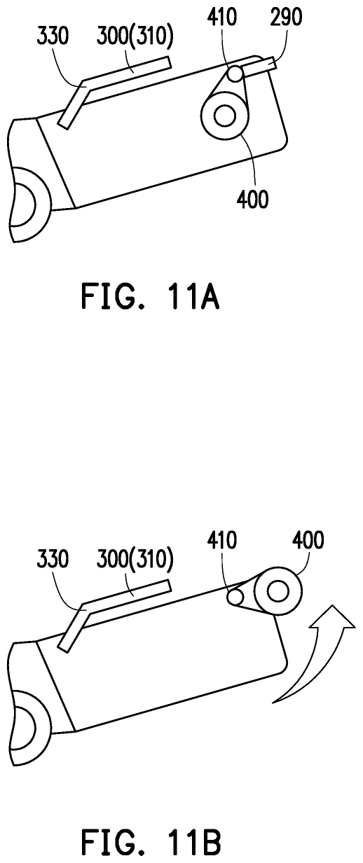

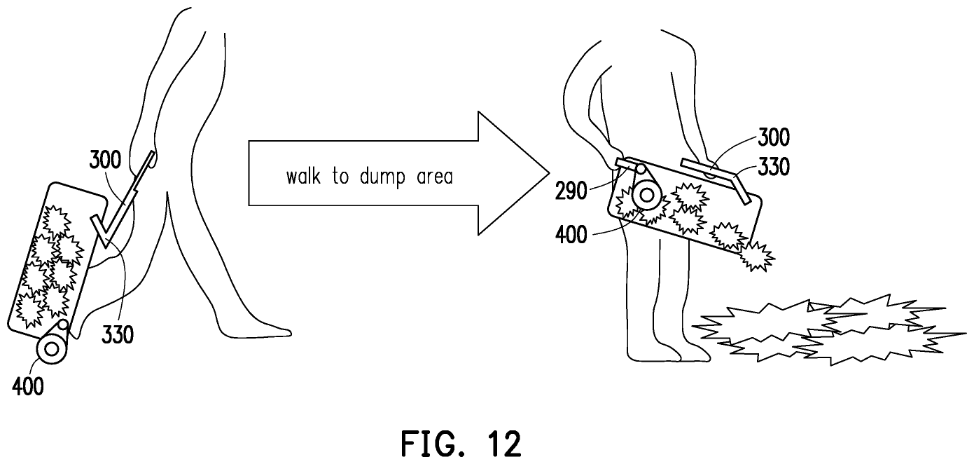

FIG. 11A is a schematic diagram illustrating a configuration of a wheel of a grass bag according to an embodiment of the disclosure. FIG. 11B is a schematic diagram illustrating a configuration of a wheel of a grass bag according to an embodiment of the disclosure. FIG. 11A and FIG. 11B are simplified drawings for illustrating a configuration of the wheel 400 of the grass bag structure 10 only, and the specific components of the grass bag structure 10 such as the first shaft 110, the second shaft 120, the third shaft 130, the fourth shaft 140, the first shaft 150 and the like are omitted. Referring to FIG. 11A and FIG. 11B, the pivot point 330 of the handle 300 may be disposed away from the bag frame 200. In addition, the wheel 400 may include a wheel pivot point 410. The grass bag structure 10 may further include a rear handle 290 fixed to a rear portion of the grass bag structure 10. The wheel pivot point 410 is located away from a rotation axis of the wheel 400. That is to say, the rotation axis of the wheel 400 during the transport state is different from the pivot point 410. The wheel 400 may be rotated about the wheel pivot point 410 such that a position of the wheel 400 may be changed by the user. For example, the wheels 400 may be configured to fold inward by rotation, when the grass bag structure 10 is in a storage state. Conversely, the wheels 400 may be configured to flip outward, when the grass bag structure 10 is in a transport state. In this way, the wheel 400 may be flipped out according to needs such that the user may be prevented from getting dirty.

FIG. 12 is a schematic diagram illustrating a concept of carrying a grass bag to a dumping area and dumping out the grass according to an embodiment of the disclosure. Referring to FIG. 12, the wheels 400 are flipped outward for transporting the grass bag structure 10 to the dumping area. In addition, the user may grip the rear handle 290 and the handle 300 to dump out the grass. The user may use the handle 400 and the rear grip 290 to shake out the grass from the grass bag structure 10.

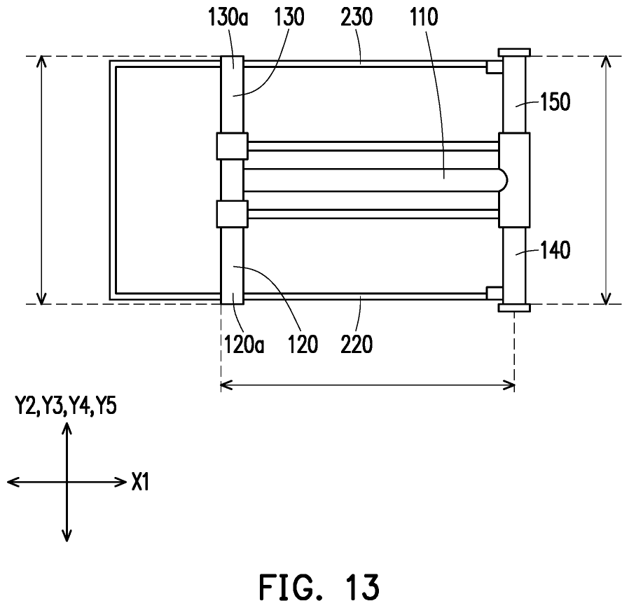

FIG. 13 is a schematic diagram illustrating a top view of an extendable and retractable trolly unit according to an embodiment of the disclosure. Referring to FIG. 13, when the trolly unit 100 is a separate unit detachably attached to the bag frame 200, then the trolly unit 100 may be detachably attached to bag frames of different size and dimensions. In the present embodiment, the first shaft 110, the second shaft 120, the third shaft 130, the fourth shaft 140 and the fifth shaft 150 may further include a telescopic rod (not shown), respectively. The telescopic rod included in the shafts 110˜150 are examples of an extension part. In more detail, the first end of the first shaft is extendable and retractable telescopically with respect to the second end of the first shaft. The second end of the second shaft is extendable and retractable telescopically with respect to the first end of the first shaft. The second end of the third shaft is extendable and retractable telescopically with respect to the first end of the first shaft. The second end of the fourth shaft is extendable and retractable telescopically with respect to the second end of the first shaft. The second end of the fifth shaft is extendable and retractable telescopically with respect to the second end of the first shaft. In this way, a length of the first shaft 110, the second shaft 120, the third shaft 130, the fourth shaft 140 and the fifth shaft 150 may each be lengthened or shortened, and the lengths of the shafts may be adjusted respectively according to the size or dimensions of the bag frame 200.

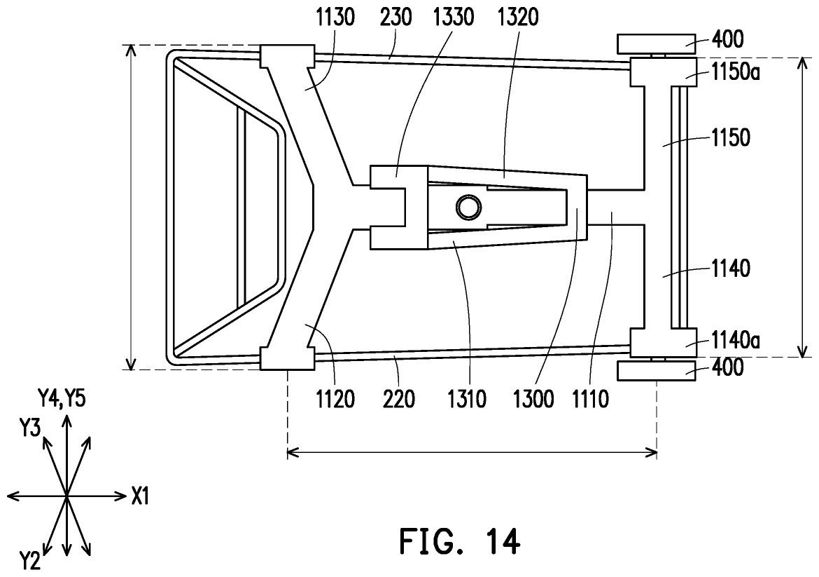

FIG. 14 is a schematic diagram illustrating a top view of an extendable and retractable trolly unit according to an embodiment of the disclosure. Referring to FIG. 14, the second shaft 1120 extends in the second direction Y2 and the third shaft 1130 extends in the third direction Y3. The second direction Y3 is a direction crossing the third direction Y3 forming a spider frame. In other words, the second direction Y2 is not parallel to the third direction Y3. In the present embodiment, the handle 1300 is rotatably coupled to the first shaft 1110 about the pivot point 1330, instead of being rotatably coupled to the second shaft 120 and the third shaft 130 such as was described, for example, in the embodiment of FIG. 1. The handle 1300 includes the first handle shaft 1310 and the second handle shaft 1320 extending from the handle 1300 to the pivot point 1330. Similar to the embodiment of FIG. 13, in FIG. 14 when the trolly unit is a separate unit detachably attached to the bag frame, then the trolly unit may be detachably attached to bag frames of different size and dimensions. In the present embodiment, the first shaft 1110, the second shaft 1120, the third shaft 1130, the fourth shaft 1140 and the fifth shaft 1150 may further include a telescopic rod (not shown), respectively. The telescopic rod included in the shafts 1110˜1150 are examples of an extension part. The embodiment of FIG. 14 also includes the fixing parts 1140a and 1150a. In more detail, the first end of the first shaft is extendable and retractable telescopically with respect to the second end of the first shaft. The second end of the second shaft is extendable and retractable telescopically with respect to the first end of the first shaft. The second end of the third shaft is extendable and retractable telescopically with respect to the first end of the first shaft. The second end of the fourth shaft is extendable and retractable telescopically with respect to the second end of the first shaft. The second end of the fifth shaft is extendable and retractable telescopically with respect to the second end of the first shaft. In this way, a length of the first shaft 1110, the second shaft 1120, the third shaft 1130, the fourth shaft 1140 and the fifth shaft 1150 may each be lengthened or shortened, and the lengths of the shafts may be adjusted respectively according to the size or dimensions of the bag frame.

In the embodiment of FIG. 14, the fourth direction Y4 is parallel to the fifth direction Y5. However, the disclosure is not limited thereto. In another embodiment of the disclosure, the fourth direction Y4 may be a direction crossing the fifth direction Y5 forming a spider frame. In other words, the fourth direction Y4 is not required to be parallel to the fifth direction Y5. The embodiment of FIG. 14 may further includes a locking mechanism (switch) disposed on the first shaft 1110 for locking and unlocking the telescopic rod from extending and retracting.

It should be noted, in another embodiment of the disclosure, the first end of the stand pipe 160 may extend to the other side of the base frame 210, and the first end of the stand pipe 160 may include a second rear shaft (not shown) disposed at the first end of the stand pipe 160, and a plurality of wheels 400 may be disposed on the second rear shaft.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A grass bag structure comprising:
a bag frame;
a handle adapted for transporting the grass bag disposed on the grass bag; and
a plurality of wheels.

2. The grass bag structure according to claim 1, wherein the handle includes a rotating part having a pivot point, adapted to fold the handle when the handle is not in use.

3. The grass bag structure according to claim 2,
wherein the bag frame comprises:
a base frame;
a second rod extending from the base frame;
a third rod extending from the base frame; and
the grass bag structure comprises:
a second shaft connected with a third shaft forming a front shaft;
a fourth shaft connected with a fifth shaft forming a rear shaft;
wherein the front shaft is coupled to the second rod and the third rod, and the rear shaft is coupled to the second rod and the third rod, and the rotating part of the handle is disposed on the front shaft.

4. The grass bag structure according to claim 3, wherein the plurality of wheels are disposed on the rear shaft.

5. The grass bag structure according to claim 4, wherein an end of the handle away from the rotating part is fixed to the rear shaft.

6. The grass bag structure according to claim 5, wherein the end of the handle away from the rotating part includes a half cylinder shape having a substantially same shape as a shape of the rear shaft.

7. The grass bag structure according to claim 6 further comprising a first shaft connecting the front shaft and the rear shaft.

8. The grass bag structure according to claim 7, wherein the handle includes a first handle shaft and a second handle shaft connecting the handle with the pivot point respectively, and the first handle shaft and the second handle shaft are separated by a space, the space is greater than a width of the first shaft.

9. The grass bag structure according to claim 8, further comprising a stand pipe extending from the rear shaft in a direction of the base frame.

10. The grass bag structure according to claim 9, wherein the handle further includes a telescopic rod configured to fold the handle when the handle is not in use.

11. The grass bag structure according to claim 10, further comprising a cover configured to cover an opening of the grass bag, and the handle of the grass bag is provided with a latching part configured to latch onto the cover.

12. The grass bag structure according to claim 11, wherein the latching part comprises a magnet.

13. The grass bag structure according to claim 12, wherein the plurality of wheels are disposed on a base frame side of the grass bag structure, and each of the plurality of wheels include a wheel pivot point located away from a rotation axis of the wheel respectively.

14. A lawn mower comprising:
the grass bag structure according to claim 1;
a housing;
a driving part comprising an engine;
a working part, comprising a cutter blade disposed rotatably inside the housing;
wherein the grass bag is mounted to the housing, and the handle of the grass bag is disposed on a side of the grass bag away from the working part.

15. A lawn mower comprising:
the grass bag structure according to claim 1;
a housing;
a driving part comprising an engine;
a working part, comprising a cutter blade disposed rotatably inside the housing;
wherein the grass bag is mounted to the housing, and the plurality of wheels are disposed on a side of the grass bag away from the engine.
